(19) United States
(12) Patent Application Publication
(10) Pub. No.: US 2024/0338251 A1
(43) Pub. Date: Oct. 10, 2024

(54) THREAD LOCAL EVENT BASED PROFILING WITH PERFORMANCE AND SCALING ANALYSIS

(71) Applicant: Maxon Computer GmbH, Bad Homburg (DE)

(72) Inventor: Sven Behne, Bad Homburg (DE)

(73) Assignee: Maxon Computer GmbH, Bad Homburg (DE)

(21) Appl. No.: 18/612,900

(22) Filed: Mar. 21, 2024

Related U.S. Application Data
(60) Provisional application No. 63/457,335, filed on Apr. 5, 2023.

(51) Int. Cl. G06F 9/50

(52) U.S. Cl. CPC G06F 9/5016

(57) ABSTRACT

The present embodiments relate to collecting and analyzing event data in a multithreaded system with an increased efficiency in processing resources. A profiling system can be integrated with the threading system to collect event data of a cache line size into a local ring buffer. The ring buffer can be aligned and sized to fit into a cache, such as a CPU L2 cache or a L1 cache. The threading system can store events for various job groups and distribution of items to the worker threads. After collecting event data, the start and end of the events can be synchronized for easier analysis and graphical display of event data. Further, various outputs (e.g., a heatmap) can be generated to illustrate various aspects of events and threads, such as a scope of each event/thread.

### CROSS-REFERENCE TO RELATED APPLICATION(S)

The present application claims priority to U.S. Provisional Patent Application No. 63/457,335, titled “THREAD LOCAL EVENT BASED PROFILING WITH PERFORMANCE AND SCALING ANALYSIS,” and filed Apr. 5, 2023, the entirety of which is incorporated by reference in its entirety herein.

### TECHNICAL FIELD

The present disclosure relates to systems and methods for collecting and analyzing event data in a multithreaded system with an increased efficiency in processing resources.

### BACKGROUND

A computing system can include one or more computing nodes configured to perform one or more processes. For example, the processes generated by the computing system can include rendering a video or generating a model from a set of input data.

In performance of such processes, a series of events can be performed. An event can include a processing task being performed using one or more computing resources (e.g., processors) in the computing system. Each event can have a start time and end time and can be part of a thread.

A thread can include a series of related events in performance of one or more processing tasks. A thread can be a self-contained sequence of instructions that can execute in parallel with other threads that are part of the same root process. Events that are part of a thread can be initiated responsive to completion of another event in the thread. For example, completion of a first event in a thread can allow for starting a second event in the thread.

### SUMMARY OF THE DISCLOSURE

The present embodiments relate to collecting and analyzing event data in a multithreaded system with an increased efficiency in processing resources. A profiling system can be integrated with the threading system to collect event data of a cache line size into a local ring buffer. The ring buffer can be aligned and sized to fit into a cache, such as a CPU L2 cache or a L1 cache. The threading system can store events for various job groups and distribution of items to the worker threads. After collecting event data, the start and end of the events can be synchronized for easier analysis and graphical display of event data. Further, various outputs (e.g., a heatmap) can be generated to illustrate various aspects of events and threads, such as a scope of each event/thread.

In a first example embodiment, a computer-implemented method is provided. The computer-implemented method can include collecting data relating to each event being executed at a specific time instance by a computing system. Each event can be part of a thread of associated events. The computer-implemented method can also include generating, for each thread, a ring buffer specifying each event being executed at the specific time instance. The computer-implemented method can also include storing data relating to each event of the thread in the ring buffer. The computer-implemented method can also include retrieving stored data from one or more ring buffers. The computer-implemented method can also include generating an output representing the stored data from the ring buffer. The computer-implemented method can also include causing display of the output.

In some instances, the ring buffer stored per thread events with a size that corresponds with a CPU L2 cache or a L1 cache.

In some instances, the size of the event data is 64 bytes.

In some instances, the data collected for each event includes any of: a time stamp, an event type, and one or more type-specific parameters.

In some instances, a scope of each event is derived based on aggregating a timing of each event being executed.

In some instances, the graphical representation comprises a heatmap.

In another example embodiment, a system is provided. The system can include one or more processors and one or more non-transitory processor readable storage devices. The storage devices can include instructions which, when executed by the one or more processors, cause the one or more processor to perform operations comprising collecting data relating to each event being executed at a specific time instance. Each event can be part of a thread of associated events. The operations can also include generating, for each thread, a buffer specifying each event being executed at the specific time instance. The operations can also include generating an output representing the data from the buffer and causing display of the output.

In some instances, the operations further comprise storing data relating to each event of the thread in the buffer and retrieving stored data from the buffer, wherein the output is generated based on the stored data of the buffer.

In some instances, the buffer comprises a ring buffer.

In some instances, the ring buffer stores per thread events with a size that corresponds with a CPU L2 cache or a L1 cache.

In some instances, the size of the event data is 64 bytes.

In some instances, the data collected for each event includes any of: a time stamp, an event type, and one or more type-specific parameters.

In some instances, a scope of each event is derived based on aggregating a timing of each event being executed.

In some instances, the graphical representation comprises a heatmap.

In another example embodiment, one or more non-transitory computer-readable media comprising instructions are provided that, when executed by one or more processors, cause the one or more processors to perform operations. The operations can include collecting data relating to each event being executed at a specific time instance by a computing system. Each event can be part of a thread of associated events. The operations can also include generating, for each thread, a ring buffer specifying each event being executed at the specific time instance. The operations can also include storing data relating to each event of the thread in the ring buffer. The operations can also include retrieving stored data from one or more ring buffers. The operations can also include generating an output representing the stored data from the ring buffer. The operations can also include causing display of the output.

In some instances, the ring buffer stored per thread events with a size that corresponds with a CPU L2 cache or a L1 cache.

In some instances, the size of the event data is 64 bytes.

In some instances, the data collected for each event includes any of: a time stamp, an event type, and one or more type-specific parameters.

In some instances, a scope of each event is derived based on aggregating a timing of each event being executed.

In some instances, the graphical representation comprises a heatmap.

Additional objects and advantages of the disclosed embodiments will be set forth in part in the description that follows, and in part will be apparent from the description, or may be learned by practice of the disclosed embodiments. The objects and advantages of the disclosed embodiments will be realized and attained by means of the elements and combinations particularly pointed out in the appended claims.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1A is an illustration of an example set of threads in performance of a process in accordance with certain aspects described herein.

FIG. 1B is a first illustration of a first set of snapshots of events that are part of multiple threads in accordance with certain aspects described herein.

FIG. 1C is a second illustration of a first set of snapshots of events that are part of multiple threads in accordance with certain aspects described herein.

FIG. 1D is an illustration of a second set of snapshots of events that are part of multiple threads in accordance with certain aspects described herein.

FIG. 2 illustrates an example pattern identified in a profiler profiling a number of events in accordance with certain aspects described herein.

FIG. 3 illustrates an example computing system in accordance with certain aspects described herein.

FIG. 4A illustrates a first example ring buffer in accordance with certain aspects described herein.

FIG. 4B illustrates a second example ring buffer in accordance with certain aspects described herein.

FIG. 5 is an example series of captured events in accordance with certain aspects described herein.

FIG. 6 is an example UI output in accordance with certain aspects described herein.

FIG. 7 is an example method for collecting and generating a graphical representation of event data in a multithreaded system in accordance with certain aspects described herein.

FIG. 8 is an illustration of an example networked system in accordance with certain aspects described herein.

FIG. 9 is an illustration of an example computer system in accordance with certain aspects described herein.

### DETAILED DESCRIPTION

A computing system can include one or more computing nodes configured to perform one or more processes. For example, the processes generated by the computing system can include rendering a three-dimensional (3D) video or generating a model from a set of input data.

In performance of such processes, a series of events can be performed. An event can include a processing task being performed using one or more computing resources (e.g., processors) in the computing system.

A thread can include a series of related events in performance of a process. A thread can be a self-contained sequence of instructions that can execute in parallel with other threads that are part of the same root process. Events that are part of a thread can be initiated responsive to completion of another event in the thread. For example, completion of a first event in a thread can allow for starting a second event in the thread.

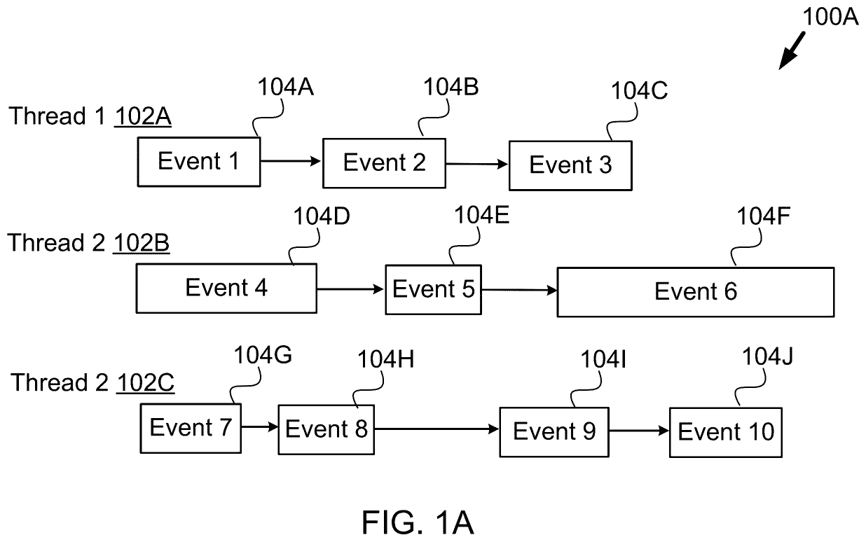

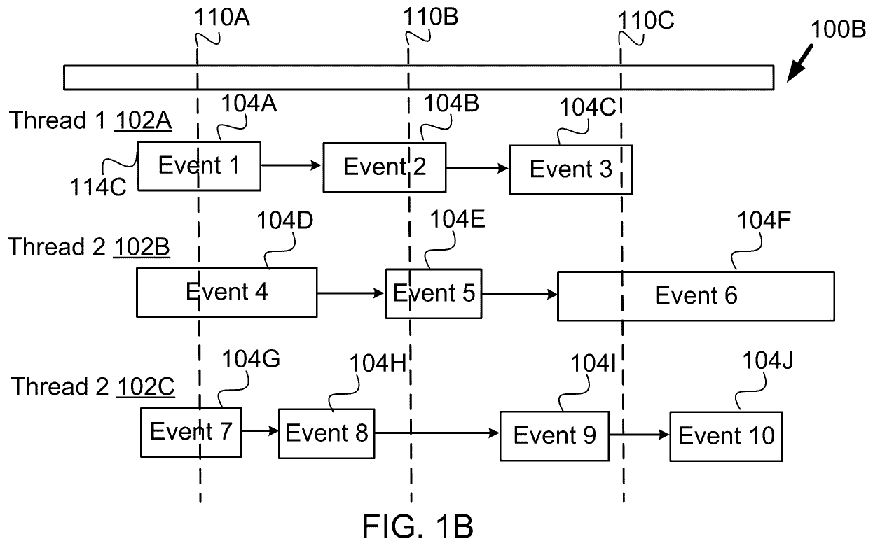

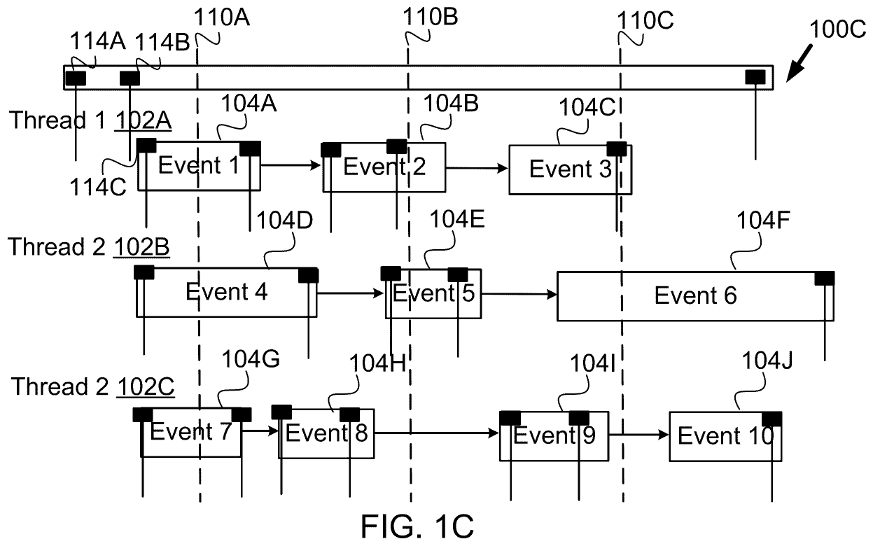

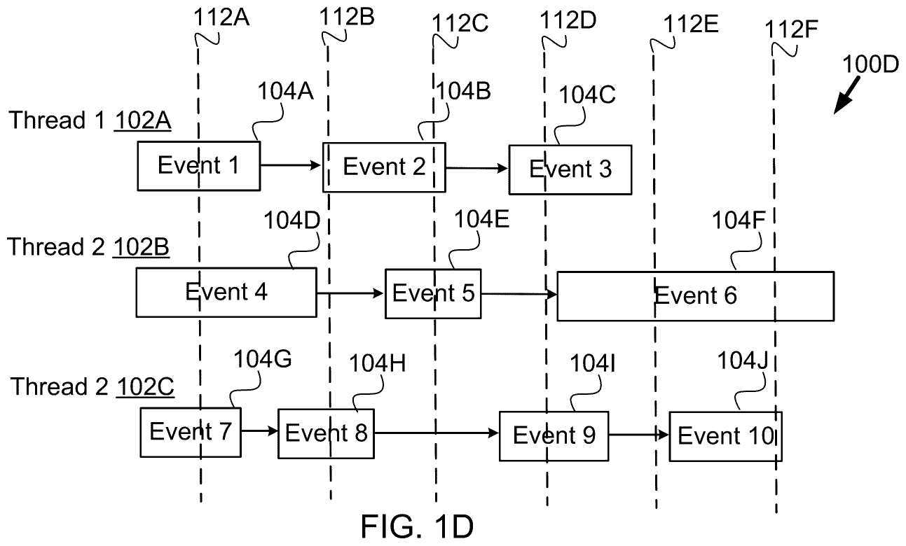

FIG. 1A is an illustration 100A of an example set of threads 102A-C in performance of a process. As shown in FIG. 1A, a thread (e.g., 102A) can include a series of events (e.g., event 1 104A, event 2 104B, event 3 104C). The thread of events can be time-based, where completion of processing a first event (e.g., event 1 104A) can initiate processing of a second event (e.g., event 2 104B). Further, each event can include a processing duration, as illustrated by a width of each event (104A-J), for example.

Further, multiple separate threads of events can be processed in performance of a process. For example, threads 102A, 102B, and 102C can each be processed as part of a multithreading system. Each thread can execute events as part of individual threads. For instance, thread 2 102B can include a series of events (e.g., event 4 104D, event 5 104E, event 6 104F), and thread 3 102C can include another series of events (e.g., event 6 104H, event 7 104H, event 8 104I, event 9 104J).

Multithreading can include a CPU feature that can allow two or more instruction threads to execute independently while sharing the same process resources. Further, multithreading can allow for multiple concurrent tasks can be performed within a single process.

For multithreaded applications, there can include a pattern where a control thread triggers actions on multiple worker threads and is notified when the result of these work items (jobs) is available. For example, an application can display a button in a dialog. When a user clicks the displayed button, a UI thread can start asynchronous actions or a parallelized set of actions on a loop which runs on the worker threads.

In such multithreading processing systems, a large number of events can be performed in a specific time duration. Among the large number of events, one or more events can be inefficiently implemented (e.g., an event can be processed by a computing resource longer than needed or expected, an event can take more than an expected amount of computing resources to process). In many cases, it is desirable to identify such events and to modify various aspects of the event to improve the efficiency in executing the event.

In many instances, a profiler can be implemented to process the multithreading system and identify aspects of the events being processed during a time duration. The profiler can take a time-based profile of events (and threads of events) being performed at a given time instance, which can be represented as a snapshot of a call stack for each thread.

FIG. 1B is an illustration 100B of a first set of snapshots 110A-C of events that are part of multiple threads. For example, as shown in FIG. 1B, a first snapshot 110A can be taken at a first time when event 1 104A, event 4 104D, and event 7 104G are each being executed in different threads 102A-C. Further, second snapshot 110B can be taken at a second time when event 2 104B and event 5 104F are each being executed in different threads 102A-B. Also, a third snapshot 110C can be taken at a third time when event 3 104C and event 6 104F are each being executed in different threads 102A-B.

However, many profilers periodically take snapshots of all events being performed during a time. But even with high periodicity, there is a chance that events are missed. For example, many profilers are unable to take snapshots with a periodicity that can capture all events being performed during a time duration. For instance, if a profiler captures a snapshot every 10 milliseconds (ms), an event that begins and ends within 5 ms may never be captured by the profiler.

For example, as shown in FIG. 1B, a portion of the events (e.g., event 8 104H, event 9 104I, and event 10 104J are not captured in any snapshot 110A-C. The inability to capture each event can be at least partially due to the periodicity of the snapshots being taken by the profiler. Further, in FIG. 1C, a series of event recording instances (e.g., 114A-C) indicative of a recordation of a start and/or an end of each event 104A-J or other incidents relating to the event.

FIG. 1D is an illustration 100D of a second set of snapshots 112A-F of events that are part of multiple threads. As shown in FIG. 1D, the second set of snapshots 112A-F can have a greater periodicity than the first set of snapshots 110A-C. Further, each of the second set of snapshots 112A-F can capture each event 104A-J such that information for each event can be stored for further analysis as described herein.

Many profilers can use a large amount of computational resources to process and obtain information for each thread, particularly in systems with large amounts of a threads and/or events being executed. The increased amount of computing resources used to implement the profiler can be inefficient and can limit the maximum possible periodicity of capturing snapshots of the threads. Such profilers can have a huge performance penalty and may be developers-only tools. Accordingly, the time-based sampling frequency can be too low to analyze complex distributed threaded workloads. There exists a need for a tool that can calculate scope-based scaling in a meaningful way.

The present embodiments relate to collecting and analyzing event data in a multithreaded system with an increased efficiency in processing resources. A profiling system can be integrated with the threading system to collect event data of a cache line size into a local ring buffer. The ring buffer can be aligned and sized to fit into a cache, such as a CPU L2 cache or a L1 cache. The threading system can store events for various job groups and distribution of items to the worker threads. After collecting event data, the start and end of the events can be synchronized for easier analysis and graphical display of event data. Further, various outputs (e.g., a heatmap) can be generated to illustrate various aspects of events and threads, such as a scope of each event/thread.

A scope can include a period in time with a start and end stamp and an associated name. For the purpose of profiling code, the name can include a function name, a name of an operation, or a name of an object which is being processed.

The present embodiments can allow for identifying events of multiple threads with higher accuracy and efficiency. The information obtained from the snapshots can identify start/end times of each event, a thread associated with each event, and/or other parameters associated with each event.

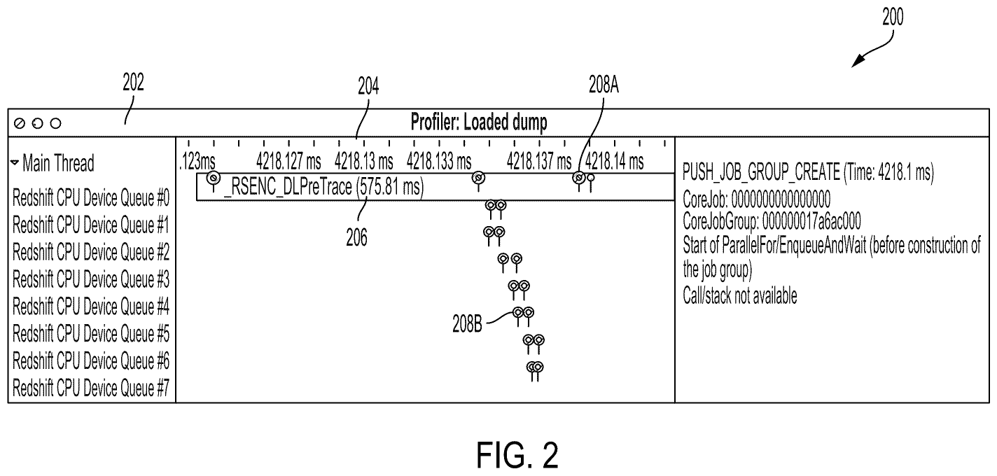

FIG. 2 illustrates an example pattern identified in a profiler profiling a number of events. As shown in FIG. 2, a view of the profiler 200 can depict a list of profiled threads 202, a timeline 204 and a series of events 208A-B. A grouping of events can be part of a trace 206.

As shown in FIG. 2, a timeline 204 can be shown below the window title. The left-hand area can include a list of profiled threads 206. Each of the icons under the timeline can represent a profiling event, for example. For instance, a scope (RSENC_DLPreTrace) of a render kernel being executed on the control thread can be shown as trace 206.

Further, a job group can be created (indicated by PUSH_JOB_GROUP_CREATE event). The jobs can be enqueued on the worker threads (PUSH_JOB_GROUP_ENQUEUE_FIFO). Further, the worker threads can be woken up (THREAD_WAKE_UP) and can fetch their jobs and run the payload (RUN_WORKER_BEGIN).

In general, the profiling system can perform three main steps: recording, collecting and analyzing. Each of mentioned events can be recorded in a thread-local ring buffer by the profiling system. A thread can collect the thread-local events and merge them into a structure for further analysis or display. This can happen in a periodic manner, but in some instances, the caller can opt to collect all available data after the profile run without any additional thread and without any periodicity. After collection, the data can be displayed (e.g., as shown in FIG. 2), written as text, csv, binary, transmitted via internet or analyzed in multiple ways. Periodic collection can be optional, and analysis can be performed independently.

Each event can have a time stamp with a resolution in the nanosecond range. This can be supplied by a CPU counter or an interrupt, but for the purpose of profiling it may be an arbitrary value to associate the profiling events with an action of interest or might refer to a state of the system being profiled. In any case, there may not include any periodic snapshots and the likelihood of events on different threads sharing the same stamp can be unlikely (when the time stamp provider has a high resolution).

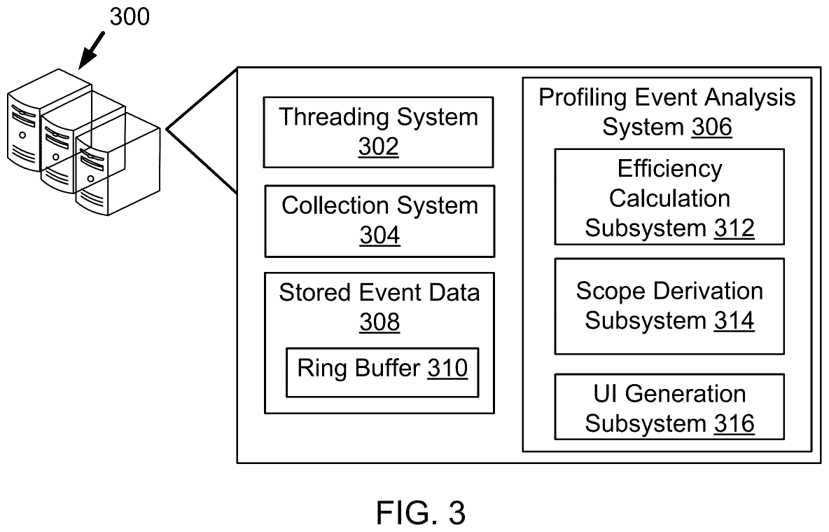

FIG. 3 illustrates an example computing system 300. The computing system 300 can include one or more interconnected computing nodes configured to perform processing as described herein. As shown in FIG. 3, the computing system 300 can include a threading system 302. The threading system 302 can generate and execute events that are part of one or more threads as described herein. The threading system 302 can also generate data specific to each event, such as an event start/stop time, an event type, and/or type specific parameters.

The computing system 300 can also include a collection system 304. The collection system 304 can periodically collect data relating to events and threads being executed at a time instance. The collection system 304 can generate stored event data 308 that can be subsequently processed as described herein. For instance, the collection system 304 can generate a ring buffer 310 that can be entered into cache.

The computing system 300 can also include a profiling event analysis system 306. The profiling event analysis system 306 can process the stored event data 308 captured by the collection system 304 and can generate insights into the events/threads in the stored event data.

The profiling event analysis system 306 can include an efficiency calculation subsystem 312. The efficiency calculation subsystem 312 can derive one or more efficiency characteristics of the threading system. For instance, efficiency of the threading system and the duration of multithreaded payload can be calculated via start and end stamps of group events and the stamps for execution on the worker threads. Furthermore, details like latency, idle or sleep time of worker threads can be evaluated via the efficiency calculation subsystem 312.

The profiling event analysis system 306 can also include a scope derivation subsystem 314. The scope derivation subsystem 314 can calculate a scope of each event and thread included in the stored event data. For scopes of interest, the amount and efficiency of multithreaded work can be recorded. Further, scopes of the same type can be accumulated to calculate their overall timing. The scope of each event/thread can be indicative of an efficiency of each event/thread.

The profiling event analysis system 306 can also include a user interface (UI) generation subsystem 316. The UI generation subsystem can generate a UI representation of the stored event data, efficiency calculations, and/or a scope of each event/thread. Example graphical representations can include a heatmap, table, chart, etc.

After collecting and merging the data there are more ways than displaying the events in a timeline or a heat map. Based on the scope data and events from the threading system a lot of useful data can be derived. For example, any of the amount of time which was single-threaded only (on the control thread), the amount of multithreaded work, the overhead of the threading system, and/or the amount of sleep/unemployment of worker threads can be calculated using stored data. Using this data, it can be determined how much multithreading in the profiled code should speed up the application. For example, a method which performs a lot of single-threaded work on the control thread might only get a maximum speedup of 4x even though it uses 32 worker threads in some parts. Furthermore, a developer can compare this value with the effectively measured speedup to judge the effectiveness of the code. By aggregating the profiled data by scope, a summary can be generated for developers as text and csv.

Comparing the summary data for a profile run with 1 thread to a run with N threads can deliver the effective scaling (speedup) for each scope. For instance, a developer can focus on the code/scope which scales improperly and has the most impact.

In some instances, the profiling can have almost no performance impact it is enabled in application versions to gather information about what happened right before an application crashed (or freeze). As already mentioned, the periodic collection can be optional. The events in the thread local ring buffers can be sufficient information about past actions. This may not include specific profiling scopes, but can include general information about threading operations and together with a crash log to be able to perform educated guesses about what went wrong and why.

Whenever a user can create complex setups, the performance implications might be hard to judge if at all. Profiling support can help to solve that. For example, in a scene graph each object can represent a scope and the execution of the scene graph to create geometry be profiled. The same can go for a node system or other complex systems. Once the system has been profiled and the data has been collected, similar to the developer view aggregation of scopes, display as a heatmap or in some cases even a timeline view can help the user to improve the performance of the setup or get an understanding where there's a bottleneck.

In comparison with some time profiling with periodic snapshots that developers frequently use, there can be many tools for it and it has its use cases when analyzing longer-running single-threaded code. The huge performance impact in this scenario is quite often tolerable because typically the observation does not influence the behavior of the observable that much that the results are skewed. This technique can be most successful when there are obvious hotspots. When running in a multithreaded context, the picture can be different. It can be ideal to use as many threads as possible so any time-consuming periodic profiling can result in preemptive scheduling by the OS scheduler and can slow down the multithreaded code far more than that's happening in the single-threaded case. Due to the periodic nature, the sampling resolution can be too low to observe relations in a multithreaded context and even if it is possible to increase the sampling frequency to the microsecond range (which can be difficult due to operating system limitations), the involved overhead could turn that effort useless. Further, if the resolution of the snapshots is too low (and it is when you're executing several ten thousand or more work items per second) there may not be a way to understand the relation between the sampled snippets. For instance, it can be difficult to understand which thread has triggered another one, why is it waiting, why is the overall scaling and performance far worse than expected. Using traditional profiling to find bottlenecks in complex multithreaded code can be a futile exercise for developers, trying to use that in an application context will first of all create unwanted slowdowns for the user and in complex setups it simply won't help.

### Collection Overview

As described above, a profiling system can be integrated with the threading system for capturing data relating to an event. The profiling system can capture event start/end times, a corresponding thread of the event, and other parameters. Per thread events (of cache line size) can be stored in a local ring buffer with queue consumer & producer properties. The ring buffer can be aligned and sized to easily fit into CPU L2 and preferably L1 caches.

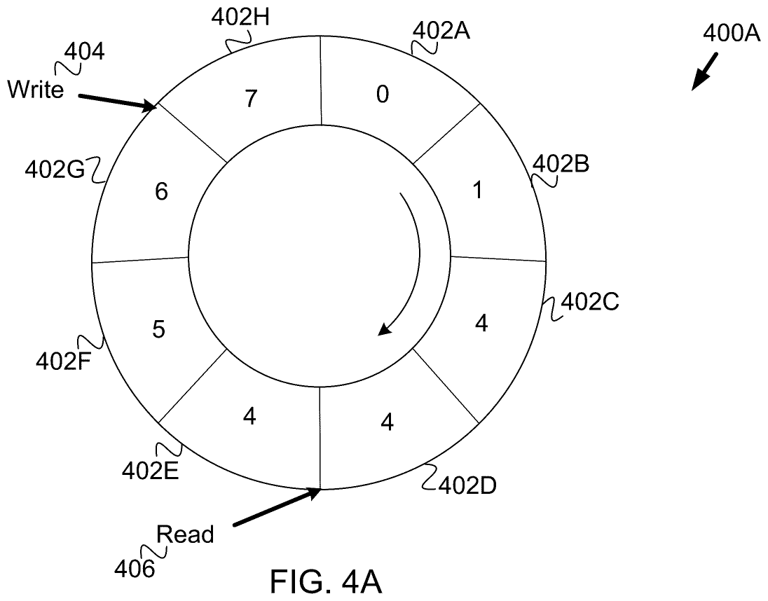

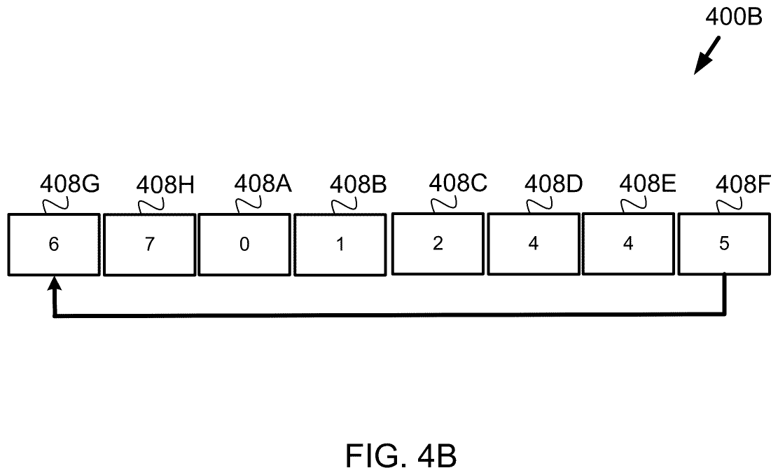

FIG. 4A illustrates a first example ring buffer 400A. As shown in FIG. 4A, the ring buffer 400A can include a data structure that stores an amount of elements 402A-H. Each element can point to an event captured by the profiling system. For instance, events and event data can be stored in the local ring buffer with queue consumer & producer properties. The ring buffer can be aligned and sized to easily fit into CPU L2 and, in some cases, L1 caches.

The ring buffer can further include a write pointer 404 and a read pointer 406. The write pointer 404 can act as a head of the buffer, while read pointer 406 can act as a tail of the buffer. The location of the pointers 404, 406 relative to one another can specify an available number of elements in the buffer. For example, as shown in FIG. 4A, the location of write butter 404 and read buffer 406 can specify available elements 402E-G in the buffer 400 as being available.

The ring buffers can maintain a circular structure. For example, if a new element is consumed from the ring buffer, the write pointer can point to the next element as the new head of the buffer, and then a new element can be inserted in the empty space. The pointer to the first element can rotate around the ring buffer as elements are consumed. The buffer can include a first in, first out (FIFO) buffer.

FIG. 4B is a second example ring buffer 400B. As shown in FIG. 4B, a series of elements 408A-H can be part of the ring buffer 400B. The buffer can start out empty, and a first element (e.g., 408A) can be written in any part of the buffer 400B. Subsequently, more elements can be added to the buffer as the profiler captures data relating to the events/threads.

Profiling events can include a CPU time stamp, event type, and type-specific custom parameters (e.g., job group, code location, nesting level, worker thread index, number of jobs, pointer to resource). The threading system can store events for job groups (e.g., parallel for loops), distribution of items to worker threads. For areas of interest (e.g., modeling kernels, nodes) scope events with a start, end, and name (and optional data) can be stored. Each element in a double ended queue can have an index. By comparing indices, samples collected by each thread can be processed to determine whether any gaps exist in the thread indicating whether data (e.g., an event) is lost. The profiling system can go into an idle or sleep state after processing so as to limit interference with the threading system.

The collecting thread can look to a memory copy of data or change pointers. Events can include 64 bytes of cache line. The cache line can further be written into the CPU. The size of the cache can be scalable to include multiple entries (e.g., 1,000, 2,000 entries). The size of the ring buffer can be modified based on the CPU architecture to capture the most information while also fitting within a cache. For example, the profiling system can collect 1000 threads at 1000 Hz, which can result in collecting data for 1,000,000 events per second with minimized interference.

Whenever possible, events can be merged and later synthesized for analysis (e.g. one scope event instead of separate start and end events) to improve CPU cache utilization. Further, a profiling thread can collect events from all participating worker threads without any locking.

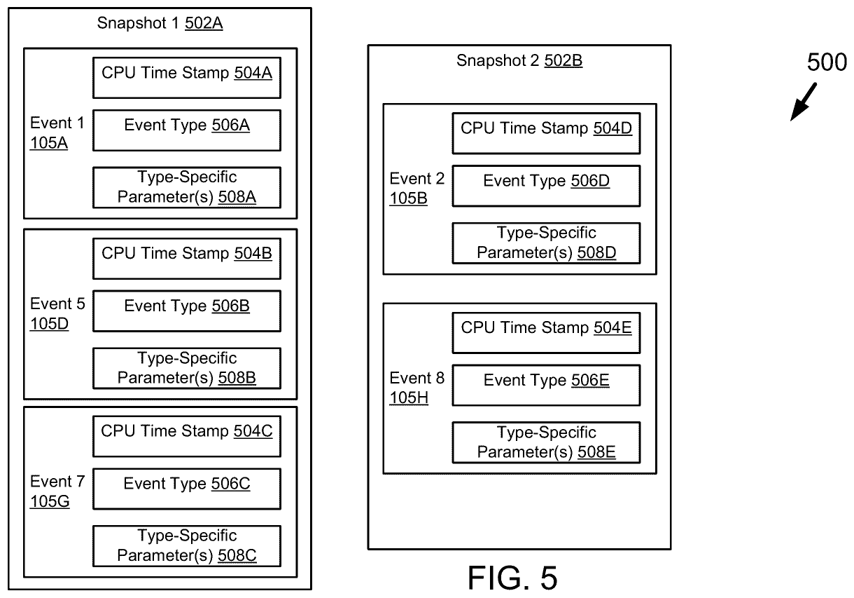

FIG. 5 is an example series of captured events 500. As shown in FIG. 5, one or more captured events 402A-B can be captured at a specific time instance. Further, captured events at a time instance can capture information from the threading system or other processes relating to events/threads being executed at a specific time instance.

For example, as shown in FIG. 5, a first set of captured events 502A can illustrate events being executed at a first time instance, such as event 1 104A, event 5 104D, and event 7 104G. Further, data relating to each event can be captured, such as CPU time stamp data 504A-C, event type data 506A-C, and type-specific parameters 508A-C.

Further, a second set of captured events 502B can include information at a second time instance, where data relating to event 2 104B and event 8 104H can be captured. Data relating to each event in the second time instance can be captured, such as CPU time stamp data 504D-E, event type data 506 D-E, and type-specific parameters 508 D-E. The data captured in each captured event can be aggregated and processed to derive insights into the events/threads as described herein.

### Profiling Event Analysis

After collection, separate start and end events from merged events can be synthesized (for simpler analysis and graphical display). The profiling event analysis can be separate from the creating and collecting the event data. Further, the analysis can be customized depending on the target audience or parameters specific to each computing system. For instance, the analysis can be customized to calculate an accumulated runtime of kernels, latency between start and response of an event, a number of events in a timeframe, etc.

An efficiency of the threading system and the duration of multithreaded payload can be calculated via start and end stamps of group events and the stamps for execution on the worker threads. Furthermore, details like latency, idle or sleep time of worker threads can be derived and evaluated. In many instances, an operator or developer can see if the algorithm is scaling to a specified set of metrics. This can be done by running code single-threaded first and then multi-threaded on one or more cores. The speedup can be a number of times faster. The workload can also be inspected to determine whether it is big enough for specific metrics. For instance, if most time is wasted idling or with general overhead, the workload of a thread can be bigger. The developer can also see if a problem can be parallelized at all. For example, if there is no speedup with more cores/threads, it can make more sense to put parallelization efforts into other tasks.

For scopes of interest, the amount and efficiency of multithreaded work can be recorded. Further, scopes of the same type can be accumulated to calculate their overall timing. Based on the timeline of the control thread and utilization of the worker threads, the expected scaling can be calculated. The same code sequence can be run with one worker thread allows to calculate the actual scaling by scope. Code scopes which do not scale linearly can be reviewed and fixed by a user (e.g., a developer). For instance, single thread performance can be compared to multi thread performance. The code can then be run single threaded and then multi-threaded to compare the speedup to the number of threads.

The analyzed event data can be represented in a UI output. An example UI output can include a heatmap or a table. For instance, a heatmap can illustrate how expensive (e.g., how many computing resources) are being used for each event and thread. The illustrations can be used to determine whether an event is inefficient and can be updated/modified.

A heat map can illustrate energy used for each event, such as to identify a specific table that is resource intensive. Another example output is to illustrate scaling kernels at start up. The output can illustrate what kernels are doing and how do the kernels scale.

Another example graphical representation of the event stream can include a traditional profile. This representation can illustrate when each thread starts doing work at micro or nanosecond level. Such representations can illustrate how much actual work is being done on threads due to high efficiency and overhead and single thread times collected.

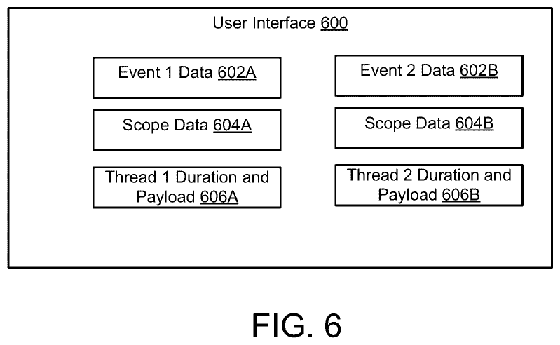

FIG. 6 is an example UI output 600. The UI output 600 can illustrate various aspects of the events captured in the captured events by the profiling system and processed by the profiled event analysis system. The UI output 600 include event data 602A-B, scope data 604A-B, and thread duration and payload data 606A-B for each event (e.g., events 1 and 2). The UI output 600 can be used to determine inefficient events or threads. Further, remediation can be made based on such insights, such as to modify code for an event to make it less resource intensive.

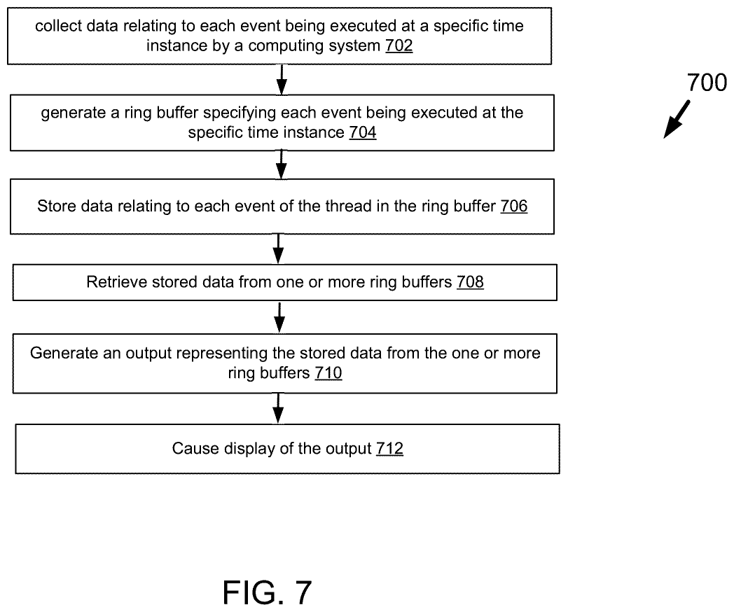

FIG. 7 is an example method for collecting and generating a graphical representation of event data in a multithreaded system. At 702, the method can include collecting data relating to each event being executed at a specific time instance by a computing system. Each event can be part of a thread of associated events. In some instances, the data collected for each event includes any of: a CPU time stamp, an event type, and one or more type-specific parameters.

At 704, the method can include generating a ring buffer specifying each event being executed at the specific time instance. In some instances, the ring buffer stored per thread events with a size that corresponds with a CPU L2 cache or a L1 cache. In some instances, the size of the ring buffer is 74 bytes.

At 706, the method can include storing data relating to the events in the thread in the ring buffer. At 708, the method can include processing data stored in the ring buffer to derive a scope of each event. In some instances, the scope of each event is derived based on aggregating a timing of each event being executed.

At 708, the method can include retrieving stored data from one or more ring buffers.

At 710, the method can include generating an output representing the stored data from the one or more ring buffers. In some instances, the graphical representation comprises a heatmap. At 712, the method can include causing display of the output.

In another example, a system is provided. The system can include one or more processors and one or more non-transitory processor readable storage devices comprising instructions which, when executed by the one or more processors, cause the one or more processor to perform operations. The operations can include collecting data relating to one or more events being executed at a time instance. The operations can also include generating a graphical representation of the collected data.

In another example embodiment, one or more non-transitory computer-readable media are described. The one or more non-transitory computer-readable media can include instructions which, when executed by one or more processors, cause the one or more processors to perform operations according to any of the embodiments as described herein.

### Network Examples

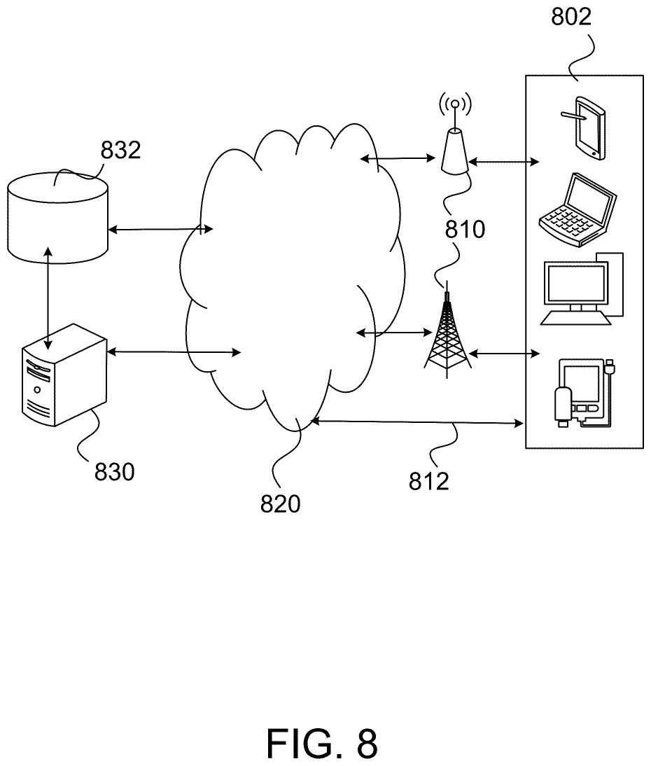

An example of a networked computing arrangement which may be utilized here is shown in FIG. 8. The computer 802 could be any number of kinds of computers alone or in combination such as those included with the camera itself, the light source itself, and/or another computer arrangement in communication with the camera and/or light computer components and in some examples, the stage motors and/or camera lens motors, including but not limited to a laptop, desktop, tablet, phablet, smartphone, or any other kind of device used to process and transmit digitized data.

Turning back to FIG. 8, computer resources for any aspect of the system may reside in networked or distributed format over the network 820. In some examples, the transmission may be through a wired connection 812. In some examples, the transmission may be through a network such as the internet 820 to the back-end server computer 830 and associated data storage 832. In some examples, the data storing, analyzing, and/or processing may be split between the local computer 802 and a back end computing system 830. Networked computer resources 830 may allow for more data processing power to be utilized than may be otherwise available at the local computers 802. In such a way, the processing and/or storage of image data may be offloaded to compute resources that are available on the network. In some examples, the networked computer resources 830 may be virtual machines in a cloud infrastructure. In some examples, the networked computer resources 830 may be spread across many multiple computer resources by a cloud infrastructure. The example of a single computer server 830 is not intended to be limiting and is only one example of a compute resource that may be utilized by the systems and methods described herein.

### Example Computer Devices

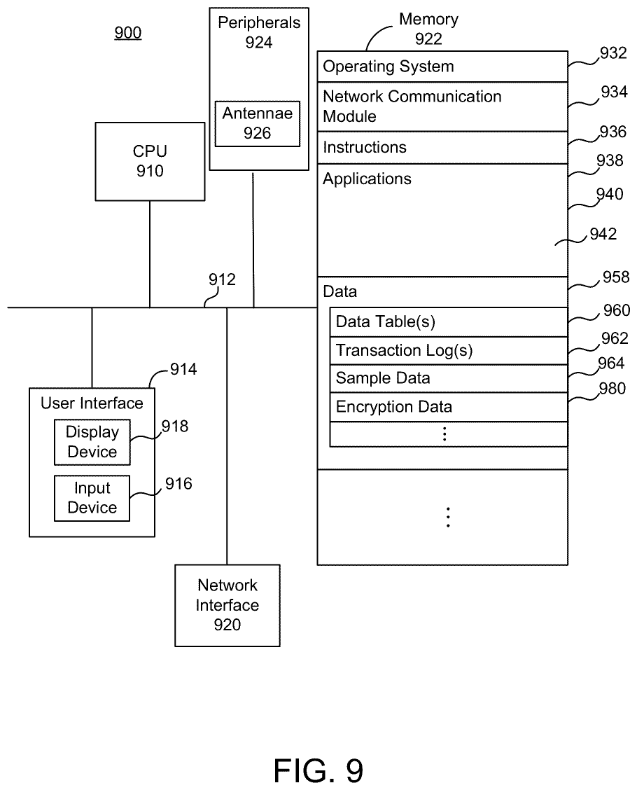

As described, any number of computing devices may be arranged into or connected with the various component parts of the systems described herein. Such systems may be local and in direct connection with the systems described herein, and in FIG. 8. In some examples, some of the computing resources may be networked, or in communication over a network, such that they are not necessarily co-located with the optics systems described herein. In any case, any of the computing systems used here may include component parts such as those described in FIG. 9.

FIG. 9 shows an example computing device 900 which may be used in the systems and methods described herein. In the example computer 900 a CPU or processor 910 is in communication by a bus or other communication 912 with a user interface 914. The user interface includes an example input device such as a keyboard, mouse, touchscreen, button, joystick, or other user input device(s). The user interface 914 also includes a display device 918 such as a screen. The computing device 900 shown in FIG. 9 also includes a network interface 920 which is in communication with the CPU 920 and other components. The network interface 920 may allow the computing device 900 to communicate with other computers, databases, networks, user devices, or any other computing capable devices. In some examples, the method of communication may be through WiFi, cellular, Bluetooth Low Energy, wired communication, or any other kind of communication. In some examples, the example computing device 900 includes peripherals 924 also in communication with the processor 910. In some examples, peripherals include antennae 926 used for communication. In some examples peripherals 924 may include camera equipment. In some example computing devices 900 a memory 922 is in communication with the processor 910. In some examples, this memory 922 may include instructions to execute software such as an operating system 932, network communications module 934, other instructions 936, applications 938, data storage 958, data such as data tables 960, transaction logs 962, sample data 964, encryption data 970 or any other kind of data.

### CONCLUSION

As disclosed herein, features consistent with the present embodiments may be implemented via computer-hardware, software and/or firmware. For example, the systems and methods disclosed herein may be embodied in various forms including, for example, a data processor, such as a computer that also includes a database, digital electronic circuitry, firmware, software, computer networks, servers, or in combinations of them. Further, while some of the disclosed implementations describe specific hardware components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various routines, processes and/or operations according to the embodiments or they may include a general-purpose computer or computing platform selectively activated or reconfigured by code to provide the necessary functionality. The processes disclosed herein are not inherently related to any particular computer, network, architecture, environment, or other apparatus, and may be implemented by a suitable combination of hardware, software, and/or firmware. For example, various general-purpose machines may be used with programs written in accordance with teachings of the embodiments, or it may be more convenient to construct a specialized apparatus or system to perform the required methods and techniques.

Aspects of the method and system described herein, such as the logic, may be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types. The underlying device technologies may be provided in a variety of component types, e.g., metal-oxide semiconductor field-effect transistor (“MOSFET”) technologies like complementary metal-oxide semiconductor (“CMOS”), bipolar technologies like emitter-coupled logic (“ECL”), polymer technologies (e.g., silicon-conjugated polymer and metal-conjugated polymer-metal structures), mixed analog and digital, and so on.

It should also be noted that the various logic and/or functions disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in various forms (e.g., optical, magnetic or semiconductor storage media) and carrier waves that may be used to transfer such formatted data and/or instructions through wireless, optical, or wired signaling media or any combination thereof. Examples of transfers of such formatted data and/or instructions by carrier waves include, but are not limited to, transfers (uploads, downloads, e-mail, etc.) over the Internet and/or other computer networks via one or more data transfer protocols (e.g., HTTP, FTP, SMTP, and so on).

Unless the context clearly requires otherwise, throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Although certain presently preferred implementations of the descriptions have been specifically described herein, it will be apparent to those skilled in the art to which the descriptions pertains that variations and modifications of the various implementations shown and described herein may be made without departing from the spirit and scope of the embodiments. Accordingly, it is intended that the embodiments be limited only to the extent required by the applicable rules of law.

The present embodiments can be embodied in the form of methods and apparatus for practicing those methods. The present embodiments can also be embodied in the form of program code embodied in tangible media, such as floppy diskettes, CD-ROMs, hard drives, or any other machine-readable storage medium, wherein, when the program code is loaded into and executed by a machine, such as a computer, the machine becomes an apparatus for practicing the embodiments. The present embodiments can also be in the form of program code, for example, whether stored in a storage medium, loaded into and/or executed by a machine, or transmitted over some transmission medium, such as over electrical wiring or cabling, through fiber optics, or via electromagnetic radiation, wherein, when the program code is loaded into and executed by a machine, such as a computer, the machine becomes an apparatus for practicing the embodiments. When implemented on a general-purpose processor, the program code segments combine with the processor to provide a unique device that operates analogously to specific logic circuits.

The software is stored in a machine-readable medium that may take many forms, including but not limited to, a tangible storage medium, a carrier wave medium or physical transmission medium. Non-volatile storage media include, for example, optical or magnetic disks, such as any of the storage devices in any computer(s) or the like. Volatile storage media include dynamic memory, such as main memory of such a computer platform. Tangible transmission media include coaxial cables; copper wire and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: disks (e.g., hard, floppy, flexible) or any other magnetic medium, a CD-ROM, DVD or DVD-ROM, any other optical medium, any other physical storage medium, a RAM, a PROM and EPROM, a FLASH-EPROM, any other memory chip, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles of the embodiments and its practical applications, to thereby enable others skilled in the art to best utilize the various embodiments with various modifications as are suited to the particular use contemplated.

What is claimed is:

1. A computer-implemented method comprising:
collecting data relating to each event being executed at a specific time instance by a computing system, wherein each event is part of a thread of associated events;
generating, for each thread, a ring buffer specifying each event being executed at the specific time instance;
storing data relating to each event of the thread in the ring buffer;
retrieving stored data from one or more ring buffers;
generating an output representing the stored data from the ring buffer; and
causing display of the output.

2. The computer-implemented method of claim 1, wherein the ring buffer stores per thread events with a size that corresponds with a CPU L2 cache or a L1 cache.

3. The computer-implemented method of claim 2, wherein the size of the event data is 64 bytes.

4. The computer-implemented method of claim 1, wherein the data collected for each event includes any of: a time stamp, an event type, and one or more type-specific parameters.

5. The computer-implemented method of claim 1, wherein a scope of each event is derived based on aggregating a timing of each event being executed.

6. The computer-implemented method of claim 1, wherein the graphical representation comprises a heatmap.

7. A system comprising:
one or more processors;
one or more non-transitory processor readable storage devices comprising instructions which, when executed by the one or more processors, cause the one or more processor to perform operations comprising:
collecting data relating to each event being executed at a specific time instance, wherein each event is part of a thread of associated events;
generating, for each thread, a buffer specifying each event being executed at the specific time instance;
generating an output representing the data from the buffer; and
causing display of the output.

8. The system of claim 7, wherein the operations further comprise:
storing data relating to each event of the thread in the buffer; and
retrieving stored data from the buffer, wherein the output is generated based on the stored data of the buffer.

9. The system of claim 7, wherein the buffer comprises a ring buffer.

10. The system of claim 9, wherein the ring buffer stores per thread events with a size that corresponds with a CPU L2 cache or a L1 cache.

11. The system of claim 10, wherein the size of the event data is 64 bytes.

12. The system of claim 7, wherein the data collected for each event includes any of: a time stamp, an event type, and one or more type-specific parameters.

13. The system of claim 7, wherein a scope of each event is derived based on aggregating a timing of each event being executed.

14. The system of claim 7, wherein the graphical representation comprises a heatmap.

15. One or more non-transitory computer-readable media comprising instructions which, when executed by one or more processors, cause the one or more processors to perform operations comprising:
collecting data relating to each event being executed at a specific time instance by a computing system, wherein each event is part of a thread of associated events;
generating, for each thread, a ring buffer specifying each event being executed at the specific time instance;
storing data relating to each event of the thread in the ring buffer;
retrieving stored data from one or more ring buffers;
generating an output representing the stored data from the ring buffer; and
causing display of the output.

16. The one or more non-transitory computer-readable media of claim 15, wherein the ring buffer stores per thread events with a size that corresponds with a CPU L2 cache or a L1 cache.

17. The one or more non-transitory computer-readable media of claim 16, wherein the size of the event data is 64 bytes.

18. The one or more non-transitory computer-readable media of claim 15, wherein the data collected for each event includes any of: a time stamp, an event type, and one or more type-specific parameters.

19. The one or more non-transitory computer-readable media of claim 15, wherein a scope of each event is derived based on aggregating a timing of each event being executed.

20. The one or more non-transitory computer-readable media of claim 15, wherein the graphical representation comprises a heatmap.
